(19) United States
(12) Patent Application Publication
(10) Pub. No.: US 2013/0189399 A1
(43) Pub. Date: Jul. 25, 2013

(54) Beverage Concentrates With Increased Viscosity And Shelf Life And Methods Of Making The Same

(71) Applicants: Karl Ragnarsson, Chester, NY (US); Daniel T. Piorkowski, Fairfield, CT (US); Katherine Josephine Meyers, Tarrytown, NY (US)

(72) Inventors: Karl Ragnarsson, Chester, NY (US); Daniel T. Piorkowski, Fairfield, CT (US); Katherine Josephine Meyers, Tarrytown, NY (US)

(21) Appl. No.: 13/791,390

(22) Filed: Mar. 8, 2013

Related U.S. Application Data
(63) Continuation-in-part of application No. 13/416,671, filed on Mar. 9, 2012.
(60) Provisional application No. 61/609,149, filed on Mar. 9, 2012.
(60) Provisional application No. 61/523,085, filed on Aug. 12, 2011.

(51) Int. Cl. A23L 2/385

(52) U.S. Cl. CPC A23L 2/385
USPC 426/73; 426/590; 426/592; 426/72

(57) ABSTRACT

Liquid beverage concentrates providing enhanced stability to flavor, artificial sweeteners, vitamins, and/or color ingredients are described herein. The liquid beverage concentrates achieve enhanced stability due to inclusion of one or more viscosity increasing agents. The liquid beverage concentrates described herein provide enhanced flavor stability to ingredients that are highly prone to degradation in acidic solutions despite the concentrates having a low pH (i.e., about 1.8 to about 3.1). In some approaches, the liquid beverage concentrates disclosed herein remain shelf stable for at least about three months when stored at 70° F. in a sealed container and can be diluted to prepare flavored beverages with a desired flavor profile and with little or no flavor degradation.

### CROSS REFERENCE TO RELATED APPLICATIONS

This application claims the benefit of U.S. Provisional Application No. 61/609,149, filed Mar. 9, 2012, and is a continuation-in-part of U.S. application Ser. No. 13/416,671, filed Mar. 9, 2012, which claims the benefit of U.S. Provisional Application No. 61/523,085, filed Aug. 12, 2011, all of which are incorporated herein by reference in their entirety.

### FIELD

The disclosure relates to liquid beverage concentrates, and particularly to shelf stable viscous concentrates suitable for dilution with a potable liquid for preparing flavored beverages.

### BACKGROUND

Flavored beverages are widely accepted by consumers and have increased in popularity in recent years. Flavored beverages are often prepared at home using powdered drink mixes, including commercially-available products like TANG®, CRYSTAL LIGHT®, and KOOL-AID® from Kraft Foods, to provide beverages in a variety of flavors, including fruit and tea flavors. Some drink mixes require the consumer to add sweetener, typically sucrose, when preparing the beverage. Other products that include sucrose often necessitate that relatively large amounts of the product be used to prepare each beverage. As the drink mixes are provided in dry form, the products generally have a long shelf life. Further, stability of the flavor ingredient is not a significant issue because beverages prepared with the drink mixes are typically consumed prior to the development of any off flavor notes in the beverage.

Flavored beverages may also be prepared from frozen, fruit-flavored concentrates, such as those traditionally sold in canisters. These concentrates typically include a large amount of water and are generally diluted at a ratio of 1 part concentrate to 3 parts water to provide the fruit flavored beverage. These types of products are often susceptible to spoilage and require storage at freezer temperatures to provide the desired shelf life.

Ready-to-drink flavored water products have also increased in popularity with numerous commercial offerings. As these products are provided in diluted form and are formulated for direct consumption, there is no additional preparation required on the part of the consumer. While these types of products require no preparation time and may provide convenience to the consumer in that regard, these types of products are bulky due to the high water content and do not allow for the consumer to adjust the amount of flavor or flavor profile of the product.

### SUMMARY

The concentrates described herein have increased viscosity which significantly improves the stability of certain ingredients despite the liquid concentrates having a pH that would be expected to rapidly degrade the ingredients. The concentrates described herein advantageously are characterized by reduced production of off-flavor notes and reduced degradation of added flavoring, coloring, vitamins, and/or sweetener during storage at 70° F. in a sealed container as compared to an otherwise identical beverage concentrates having a lower viscosity.

Beverage concentrates contain a greater amount of ingredients per unit volume than a dilute, ready-to-drink beverage. By increasing the concentration of ingredients in the beverage concentrate, the ingredients more readily come into contact with one another, which can speed up rates of reactions that are dependent on acid or oxygen-deterioration pathways and ultimately cause the concentrate to have a shorter shelf-life. Many techniques have been implemented to slow the rate acid or oxygen-catalyzed reactions, with encapsulation being one of these techniques. Encapsulation effectively quarantines sensitive beverage components away from solubilized acid or permeating oxygen, thereby reducing the rate of reaction and increasing shelf-life. However, not all beverage components have the ability to be encapsulated due to physical, chemical, or processing restraints.

Described herein is a viscous but flowable, liquid beverage concentrate including a viscosity increasing agent which provides a highly stable system relative to a comparative beverage concentrate with the same ingredients except for at least a portion of the viscosity increasing agent such that the comparative beverage concentrate has a lower viscosity as evidenced by a different taste after storage in a closed container at room temperature after six months.

In one approach, a moderately concentrated product may be formulated to be diluted by a factor of at least 5 times to provide a final beverage, which can be, for example, an 8 ounce beverage. In one aspect, the concentrate is formulated to be diluted by a factor of about 5 to about 15 times to provide a final beverage. In this form, the liquid concentrate has a pH of about 1.8 to about 3.1, 1.8 to about 2.9, in another aspect about 1.8 to about 2.7, in another aspect about 1.8 to about 2.5, and in yet another aspect about 1.8 to about 2.4, in another aspect about 2.0 to about 3.1, in another aspect about 2.0 to about 2.9, in another aspect about 2.0 to about 2.7, in another aspect about 2.0 to about 2.5, and in yet another aspect about 2.0 to about 2.4, and a viscosity of about 7.5 to about 100 cP, in another aspect about 10 to about 100 cP, in another aspect about 15 to about 100 cP, in another aspect about 7.5 to about 50 cP, in another aspect about 10 to about 50 cP, in another aspect about 7.5 to about 20 cP, and in another aspect about 10 to about 20 cP, as measured using Spindle S00 at 50 rpm at 20° C. with a Brookfield DVII+Pro Viscometer. Viscosity in the described range is effective to increase the stability of flavorings, colors, vitamins, and artificial sweeteners prone to degradation at the described pH. In one aspect, the concentrate includes at least about 0.1 percent acidulant, in another aspect about 0.1 to about 15 percent acidulant, in another aspect about 0.5 to about 10 percent acidulant, in another aspect about 0.75 to about 10 percent acidulant, in another aspect about 1 to about 10 percent acidulant, in another aspect about 0.75 to about 5 percent acidulant, and in another aspect about 1 to about 5 percent acidulant by weight of the concentrate.

In another approach, a highly concentrated product can be provided at a concentration of about 25 to about 200 times, in another aspect about 25 to about 160 times, in another aspect about 50 to about 160 times, in another aspect about 75 to about 160 times, and in yet another aspect about 75 to about 140 times that needed to provide a desired level of flavor intensity, acidity, and/or sweetness to a final beverage, which can be, for example, an 8 ounce beverage. In this form, the liquid concentrates described herein have a pH of about 1.8 to about 3.1, 1.8 to about 2.9, in another aspect about 1.8 to about 2.7, in another aspect about 1.8 to about 2.5, and in yet another aspect about 1.8 to about 2.4, in another aspect about 2.0 to about 3.1, in another aspect about 2.0 to about 2.9, in another aspect about 2.0 to about 2.7, in another aspect about 2.0 to about 2.5, and in yet another aspect about 2.0 to about 2.4, and a viscosity for a Newtonian liquid viscosity of about 7.5 to about 100 cP, in another aspect about 10 to about 100 cP, in another aspect about 7.5 to about 50 cP, in another aspect about 10 to about 50 cP, and in another aspect about 7.5 to about 40 cP, in another aspect about 10 to about 40 cP. If the concentrate instead has a non-Newtonian liquid viscosity, the viscosity may be about 7.5 to about 10,000 cP, in another aspect about 100 to about 10,000 cP, in another aspect about 50 to about 10,000 cP, in another aspect about 10 to about 10,000 cP, in another aspect about 7.5 to about 5,000 cP, in another aspect about 7.5 to about 1000 cP, in another aspect about 7.5 to about 500 cP, in another aspect about 7.5 to about 200 cP, in another aspect about 7.5 to about 100 cP, in another aspect about 7.5 to about 50 cP, and in another aspect about 7.5 to about 40 cP. Viscosity is measured using Spindle S00 at 10 rpm at 20° C. with a Brookfield DVII+Pro Viscometer; however, if the machine registers an error message using Spindle S00 for highly viscous concentrates, Spindle S06 at 10 rpm at 20° C. should be used. Viscosity in the described range is effective to increase the stability of flavorings, colors, vitamins, and artificial sweeteners prone to degradation at the described pH. In one aspect, the concentrate includes at least about 0.5 percent acidulant, in another aspect about 0.5 to about 60 percent acidulant, in another aspect about 3 to about 35 percent acidulant, in another aspect about 8 to about 35 percent acidulant, in another aspect about 8 to about 30 percent acidulant, about 10 to about 30 percent acidulant, and in yet another aspect about 15 to about 30 percent acidulant by weight of the concentrate.

The liquid concentrates described herein beneficially include one or more viscosity increasing agents to slow the rate of degradation reactions including, but not limited to, hydrolysis and oxidation, by increasing the viscosity of the concentrate to a level effective to substantially reduce the rate of degradation during storage at 70° F. in a sealed container. It was surprisingly found that, at least in some cases, rather moderate viscosity increases were effective to substantially reduce the rate of degradation reactions of certain ingredients that are highly susceptible to degradation despite the concentrates having a relatively low pH (e.g., about 1.8 to about 3.1). The concentrates described herein are particularly suitable for ingredients that are highly prone to degradation in acidic solutions, including for example, terpenes (such as limonene), sesquiterpenes, terpene alcohol, aldehyde, terpenoids (such as citral), betalains, annatto, red beet juice powder, and Vitamins A, C, and E.

### DETAILED DESCRIPTION

Viscous liquid beverage concentrates are described herein which provide enhanced stability to flavorings, artificial and natural sweeteners, vitamins, and/or color ingredients despite a substantial water content (e.g., between about 40 to about 98 percent water) and low pH (e.g., between about 1.8 to about 3.1). The liquid beverage concentrates described herein achieve enhanced stability due to increased viscosity. Advantageously, there is no significant change in flavor or development of off flavor notes, and no significant change in appearance due to color degradation or ingredient browning in the concentrate when stored at 70° F. for at least about 6 months, in another aspect at least about 9 months, and in another aspect at least about 12 months, in a sealed container. In one aspect, the container is light impermeable when the concentrate includes light sensitive components. The concentrates described herein can then be diluted in a potable liquid to provide flavored beverages with an acceptable flavor profile and/or color.

The concentrates described herein are particularly suitable for ingredients that are highly prone to degradation in acidic solutions, including for example, terpenes (such as limonene), sesquiterpenes, terpene alcohol, aldehyde, terpenoids (such as citral), betalains, annatto, red beet juice powder, and Vitamins A, C, and E. The stability of these ingredients is improved in the concentrates described herein.

Generally it is desirable that the concentrates include acidulant so that a flavored beverage made therefrom has a tart flavor that enhances the overall flavor profile of the beverage. For example, it may be desirable to provide a lemon-flavored beverage that has a tart flavor similar to that of a lemonade drink made with fresh lemons. A variety of other flavors can also be enhanced by a tart flavor, such as other fruit flavors. Higher acid contents are generally desirable for citrus flavors than for other fruit flavors.

Accordingly, more concentrated products require a greater quantity of acidulant to achieve the same level of acid content in the finished beverage upon dilution. The acid content is often detrimental to the stability of various ingredients of the liquid concentrate. It has also been found that inclusion of large amounts of water in liquid beverage concentrates can be problematic for a number of reasons. Some flavorings, sweeteners, vitamins, and/or color ingredients are rapidly degraded in water or in an acidic environment, thereby limiting the types of flavorings that are suitable for inclusion in water-based beverage concentrates or ready-to-drink beverages. For instance, some flavor degradation reactions require the presence of water while others require protons from dissociated acids. Certain types of flavorings, such as acid labile citrus flavorings containing terpenes, sesquiterpenes, terpene alcohol, and aldehyde, have greater susceptibility to degradation, and products containing them typically have very short shelf lives (even a matter of days) when stored above refrigeration temperatures due to development of off-flavor notes and alteration of the taste profile of the product. Exemplary other ingredients exhibiting instability in water and/or at low pH include, for example, vitamins, particularly vitamins A, C, and E (Vitamin C, for example, can undergo browning in an acidic environment), high potency sweeteners (such as, for example, monatin, neotame, Luo Han Guo), “natural” colors or other non-exempt colors listed in the Federal Food, Drug, & Cosmetic Act (such as for example fruit and vegetable extracts, anthocyanins, copper chlorophyllin, curcumin, and riboflavin), sucrose (susceptible to acid hydrolysis which can then lead to browning), protein, hydrocolloids, starch, and fiber.

The liquid concentrates described herein beneficially include one or more viscosity increasing agents to slow the rate of degradation reactions including, but not limited to, hydrolysis and oxidation, by increasing the viscosity of the concentrate to a level effective to substantially reduce the rate of degradation during storage at 70° F. in a sealed container. It was surprisingly found that, at least in some cases, rather moderate viscosity increases were effective to substantially reduce the rate of degradation reactions of certain ingredients that are highly susceptible to degradation despite the concentrates having a relatively low pH (e.g., about 1.8 to about 3.1). However, the viscosity of the concentrates is not increased to the extent that the concentrates are no longer considered flowable liquid compositions at 70° F.

As used herein, the term “liquid concentrate” means a liquid composition that can be diluted with another liquid, such as an aqueous, potable liquid to provide a final beverage or added to a food product prior to being consumed. The phrase “liquid” refers to a non-gaseous, flowable, fluid composition at room temperature (i.e., 70° F.). The term “final beverage” as used herein means a beverage that has been prepared by diluting the concentrate to provide a beverage in a potable, consumable form. In some aspects, the concentrate is non-potable due to acidulant content and/or flavor intensity. By way of example to clarify the term “concentration,” a concentration of 75 times (i.e., “75×”) would be equivalent to 1 part concentrate to 74 parts water (or other potable liquid) to provide the final beverage. In other words, the flavor profile of the final beverage is taken into account when determining an appropriate level of dilution, and thus concentration, of the liquid beverage concentrate. The dilution factor of the concentrate can also be expressed as the amount necessary to provide a single serving of concentrate.

The concentration factor of the liquid concentrate can be correlated to one or more of the ingredients in the liquid concentrate in reference to the desired level of that ingredient in the final beverage. By one approach, the concentration factor may be in terms of the acidulant content of the final beverage. For example, the concentration factor of the liquid beverage concentrate can be expressed as the level of dilution needed to obtain a final beverage having an acid range of about 0.01 to 1.0 percent by weight of the beverage, in another aspect about 0.05 to about 0.8 percent, and in yet another aspect about 0.1 to about 0.5 percent by weight of the final beverage. The amount of acid in a citrus-flavored beverage is generally desired to be higher than in other fruit-flavored beverages. Therefore, a final beverage having an acid content of about 0.1 to about 0.8 percent, in another aspect about 0.1 to about 0.5 percent, may be desired for a citrus flavored beverage, while a final beverage having an acid content of about 0.1 to about 0.5, in another aspect about 0.1 to about 0.3 percent, may be desired for a non-citrus, fruit-flavored beverage.

By another approach, the concentration factor may in terms of the sweetness of the final beverage. For example, the concentration factor can be expressed as a level of dilution needed to provide a final beverage having a sweetness level equivalent to the degree of sweetness of a beverage containing about 5 to about 25 weight percent sucrose. One degree Brix corresponds to 1 gram of sucrose in 100 grams of aqueous solution. For example, the dilution factor of the beverage concentrate can be expressed as the dilution necessary to provide an equivalent of about 5 to about 25 degrees Brix, in another aspect about 8 to about 14 degrees Brix, and in another aspect about 8 to about 12 degrees Brix, in the resulting beverage. By this approach, one or more sweeteners can be included in the concentrated flavor composition in an amount effective to provide the beverage with a level of sweetness equivalent to the desired degrees Brix relative to sucrose.

The viscosity, pH, and formulations of the concentrates will depend, at least in part, on the intended dilution factor. In one approach, a moderately concentrated product may be formulated to be diluted by a factor of at least 5 times to provide a final beverage, which can be, for example, an 8 ounce beverage. In one aspect, the concentrate is formulated to be diluted by a factor of about 5 to about 15 times to provide a final beverage. In this form, the liquid concentrate has a pH of about 1.8 to about 3.1, 1.8 to about 2.9, in another aspect about 1.8 to about 2.7, in another aspect about 1.8 to about 2.5, and in yet another aspect about 1.8 to about 2.4, in another aspect about 2.0 to about 3.1, in another aspect about 2.0 to about 2.9, in another aspect about 2.0 to about 2.7, in another aspect about 2.0 to about 2.5, and in yet another aspect about 2.0 to about 2.4, and a viscosity of about 7.5 to about 100 cP, in another aspect about 10 to about 100 cP, in another aspect about 15 to about 100 cP, in another aspect about 7.5 to about 50 cP, in another aspect about 10 to about 50 cP, in another aspect about 7.5 to about 20 cP, and in another aspect about 10 to about 20 cP, as measured using Spindle S00 at 50 rpm at 20° C. with a Brookfield DVII+Pro Viscometer. Viscosity in the described range is effective to increase the stability of flavorings, colors, vitamins, and artificial sweeteners prone to degradation at the described pH. In one aspect, the concentrate includes at least about 0.1 percent acidulant, in another aspect about 0.1 to about 15 percent acidulant, in another aspect about 0.5 to about 10 percent acidulant, in another aspect about 0.75 to about 10 percent acidulant, in another aspect about 1 to about 10 percent acidulant, in another aspect about 0.75 to about 5 percent acidulant, and in another aspect about 1 to about 5 percent acidulant by weight of the concentrate.

In another approach, a highly concentrated product can be provided at a concentration of about 25 to about 200 times, in another aspect about 25 to about 160 times, in another aspect about 50 to about 160 times, in another aspect about 75 to about 160 times, and in yet another aspect about 75 to about 140 times that needed to provide a desired level of flavor intensity, acidity, and/or sweetness to a final beverage, which can be, for example, an 8 ounce beverage. In this form, the liquid concentrates described herein have a pH of about 1.8 to about 3.1, 1.8 to about 2.9, in another aspect about 1.8 to about 2.7, in another aspect about 1.8 to about 2.5, and in yet another aspect about 1.8 to about 2.4, in another aspect about 2.0 to about 3.1, in another aspect about 2.0 to about 2.9, in another aspect about 2.0 to about 2.7, in another aspect about 2.0 to about 2.5, and in yet another aspect about 2.0 to about 2.4, and a viscosity for a Newtonian liquid viscosity of about 7.5 to about 100 cP, in another aspect about 10 to about 100 cP, in another aspect about 7.5 to about 50 cP, in another aspect about 10 to about 50 cP, and in another aspect about 7.5 to about 40 cP, in another aspect about 10 to about 40 cP. If the concentrate instead has a non-Newtonian liquid viscosity, the viscosity may be about 7.5 to about 10,000 cP, in another aspect about 100 to about 10,000 cP, in another aspect about 50 to about 10,000 cP, in another aspect about 10 to about 10,000 cP, in another aspect about 7.5 to about 5,000 cP, in another aspect about 7.5 to about 1000 cP, in another aspect about 7.5 to about 500 cP, in another aspect about 7.5 to about 200 cP, in another aspect about 7.5 to about 100 cP, in another aspect about 7.5 to about 50 cP, and in another aspect about 7.5 to about 40 cP. Viscosity is measured using Spindle S00 at 10 rpm at 20° C. with a Brookfield DVII+Pro Viscometer; however, if the machine registers an error message using Spindle S00 for highly viscous concentrates, Spindle S06 at 10 rpm at 20° C. should be used. Viscosity in the described range is effective to increase the stability of flavorings, colors, vitamins, and artificial sweeteners prone to degradation at the described pH. In one aspect, the concentrate includes at least about 0.5 percent acidulant, in another aspect about 0.5 to about 60 percent acidulant, in another aspect about 3 to about 35 percent acidulant, in another aspect about 8 to about 35 percent acidulant, in another aspect about 8 to about 30 percent acidulant, about 10 to about 30 percent acidulant, and in yet another aspect about 15 to about 30 percent acidulant by weight of the concentrate.

Any edible, food grade organic or inorganic acid, such as, but not limited to, citric acid, malic acid, succinic acid, acetic acid, hydrochloric acid, adipic acid, tartaric acid, fumaric acid, phosphoric acid, lactic acid, sodium acid pyrophosphate, salts thereof, and combinations thereof can be used, if desired. The selection of the acidulant may depend, at least in part, on the desired pH of the concentrate and/or taste imparted by the acidulant to the diluted final beverage. In another aspect, the amount of acidulant included in the concentrate may depend on the strength of the acid. For example, a larger quantity of lactic acid would be needed in the concentrate to reduce the pH in the final beverage than a stronger acid, such as phosphoric acid.

In some approaches, buffer can be added to the concentrate to provide for increased acid content at a desired pH. Use of buffer may be particularly desired for more concentrated products. Buffer can be added to the concentrate to adjust and/or maintain the pH of the concentrate. Depending on the amount of buffer used, a buffered concentrate may contain substantially more acid than a similar, non-buffered concentrate at the same pH. In one aspect, buffer may be included in an amount relative to the acidulant content. For example, the acid:buffer ratio can be about 1:1 to about 25,000:1, in another aspect about 1.25:1 to about 4000:1, in another aspect about 1.7:1 to about 3000:1, and in another aspect about 2.3:1 to about 250:1. In this respect, a buffered concentrate may include more acidulant and can be diluted to provide a final beverage with enhanced tartness due to increased acidulant content as compared to a beverage provided from an otherwise identical concentrate at the same pH but which lacks buffers. Inclusion of buffers may also be advantageous to the flavor profile in the resulting final beverage.

Suitable buffers include, for example, a conjugated base of an acid, gluconate, acetate, phosphate or any salt of an acid (e.g., sodium citrate and potassium citrate). In other instances, an undissociated salt of the acid can buffer the concentrate.

The concentrate can be formulated to have Newtonian or non-Newtonian flow characteristics depending, at least in part, on the selection of viscosity increasing agents. A concentrate having Newtonian flow characteristics is characterized by a viscosity independent of the shear rate. Inclusion of certain viscosity increasing agents, for example xanthan gum, can create pseudo-plastic and shear thinning characteristics of the concentrate. A drop in viscosity as the shear rate increases indicates that shear thinning is occurring.

Increased viscosity can be achieved by the addition of one or more viscosity increasing agents in an amount effective to increase the viscosity of the concentrate to the desired level. For example, the viscosity increasing agent may be a nutritive sweetener, polyol, juice or juice concentrate, gum, gum derivative, cellulose derivative, gelatin, polysaccharide, carbohydrate, viscous solvent, starch, or combinations thereof. The amount of the viscosity increasing agent included in the concentrates described herein will depend, at least in part, on the amount necessary to achieve the desired viscosity.

Exemplary gums include, for instance, xanthan gum, guar gum, gum arabic, tragacanth, gum karaya, gum ghatti, locust bean gum, quince seed gum, and tamarind gum. Exemplary polysaccharides include, for instance, dextran, carrageenan, furcellaran, arabinogalactan, alginate, pectin, and agar. Exemplary cellulose derivatives include, for instance, carboxymethyl cellulose, hydroxypropyl methylcellulose, and microcrystalline cellulose. Exemplary carbohydrates include, for instance, psyllium. Exemplary gum derivatives include, for instance, propylene glycol alginate and low-methoxyl pectin. Starches derived from arrowroot, corn, potato, rice, sago, tapioca, waxy corn and wheat can also be used to build up viscosity.

Viscosity can also be increased by adding nutritive sweeteners such as, for example, honey, sucrose, fructose, glucose, tagatose, trehalose, galactose, rhamnose, cyclodextrin (e.g., α-cyclodextrin, β-cyclodextrin, and γ-cyclodextrin), maltodextrin (e.g., resistant maltodextrins such as Fibersol-2™), dextran, ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, amylopectin, glucosamine, mannosamine, fucose, glucuronic acid, gluconic acid, glucono-lactone, abequose, galactosamine, beet oligosaccharides, isomalto-oligosaccharides (e.g., isomaltose, isomaltotriose, panose and the like), xylo-oligosaccharides (e.g., xylotriose, xylobiose and the like), gentio-oligosaccharides (e.g., gentiobiose, gentiotriose, gentiotetraose and the like), sorbose, nigero-oligosaccharides, palatinose oligosaccharides, fucose, fractooligosaccharides (e.g., kestose, nystose and the like), maltotetraol, maltotriol, malto-oligosaccharides (e.g., maltotriose, maltotetraose, maltopentaose, maltohexaose, maltoheptaose and the like), lactulose, melibiose, raffinose, rhamnose, ribose, isomerized liquid sugars such as high fructose corn or starch syrups (e.g., HFCS55, HFCS42, or HFCS90), coupling sugars, soybean oligosaccharides, glucose syrup, or combinations thereof.

Sweeteners included in the concentrates may include high intensity sweeteners or nutritive sweeteners, or a combination thereof, including, for example, sucralose, aspartame, saccharine, monatin, peptide-based high intensity sweeteners (e.g., Neotame®), cyclamates (such as sodium cyclamate), Luo Han Guo, acesulfame potassium, alitame, saccharin, neohesperidin dihydrochalcone, cyclamate, N—[N-[3-(3-hydroxy-4-methoxyphenyl)propyl]-L-a-aspartyl]-L-10 phenylalanine 1-methyl ester, N—[N-[3-(3-hydroxy-4-methoxyphenyl)-3-methylbutyl]-L-aaspartyl]-L-phenylalanine 1-methyl ester, N—[N-[3-(3-methoxy-4-hydroxyphenyl)propyl]L-a-aspartyl]-L-phenylalanine 1-methyl ester, salts thereof, stevia, steviol glycosides, such as rebaudioside A (often referred to as “Reb A”), rebaudioside B, rebaudioside C, rebaudioside D, rebaudioside E, rebaudioside F, rebaudioside A, rebaudioside B, rebaudioside C, rebaudioside D, rebaudioside E, rebaudioside F, dulcoside A, dulcoside B, rubusoside, stevioside, and steviolbioside, and combinations thereof. The selection of sweetener and amount of sweetener added may depend, at least in part, on the desired viscosity of the concentrated flavor composition and whether the sweetener is included as the viscosity increasing agent. For example, nutritive sweeteners like sucrose may be included in much higher amounts than high intensity sweeteners like neotame to provide the same level of sweetness and such higher total solids content contributed by the sweetener increases the viscosity of the composition. If desired, the sweetener can generally be added in an amount of about 0.2 to about 60 percent, with the lower end of the range generally more appropriate for high intensity sweeteners and the upper end of the range generally more appropriate for nutritive sweeteners. Other amounts of sweetener can also be included, if desired.

Viscosity may also be increased through the use of one or more polyol additives such as, for example, erythritol, maltitol, mannitol, sorbitol, lactitol, xylitol, inositol, isomalt, propylene glycol, glycerol (glycerine), 1,3-propanediol, threitol, galactitol, palatinose, reduced isomalto-oligosaccharides, reduced xylo-oligosaccharides, reduced gentio-oligosaccharides, reduced maltose syrup, reduced glucose syrup, or combinations thereof.

The concentrates may also include one or more juices or juice concentrates (such as at least a 4× concentrated product) from fruits or vegetables for bulk solid addition. In one aspect, the juice or juice concentrate may include, for example, coconut juice (also commonly referred to as coconut water), apple, pear, grape, orange, potato, tangerine, lemon, lime, tomato, carrot, beet, asparagus, celery, kale, spinach, pumpkin, strawberry, raspberry, banana, blueberry, mango, passionfruit, peach, plum, papaya, and combinations. The juice or juice concentrates may also be added as a puree, if desired.

By another approach, replacement of at least some water of the concentrate with a solvent having a higher viscosity than water can also increase the viscosity of the concentrate. The viscosity and density of various solvents are provided in Table 1 below. Beverage concentrates where at least some of the water in the formulation has been replaced with a solvent having a higher viscosity and density than water will result in a more viscous concentrate than a comparative concentrate prepared without the higher viscosity/density solvent but with all other ingredients included at the same levels.

TABLE 1
Approximate Physical Properties of Various
Solvents at Room Temperature

| Liquid | Viscosity (cP) | Density (g/cc) |
|---|---|---|
| Water | 1 | 1.00 |
| Ethanol | 1 | 0.79 |
| 1,3-Propanediol | 52 | 1.06 |
| Propylene Glycol | 56 | 1.04 |
| Glycerol | 1200 | 1.26 |
| Triacetin | 25 | 1.16 |

It was found that the viscosity increasing agent does not have to impact the amount of bulk (free) solvent in the concentrate in order to be effective at increasing the stability of the ingredients. For example, it was found that xanthan gum does not impact the amount of bulk solvent in the concentrate but increases the viscosity while also increasing stability of ingredients prone to degradation. However, increased viscosity can be achieved by inclusion of water-binding ingredients, such as carbohydrates (e.g., sugar), fiber, proteins, and hydrocolloids, if desired. Inclusion of water-binding ingredients can effectively slow the rate of reactions by decreasing water activity and increasing viscosity. For example, sugar effectively binds bulk (free) solvent and causes the rate of diffusion to decrease by increasing viscosity and lowering water activity. It has been observed that this method can be used as a means to slow the rate of oxidation of flavors, including, for example, lemon oil. It was found that a beverage concentrate containing sugar slowed the rate of acid-catalyzed hydrolysis and oxidation when compared to a beverage free of sugar that was instead sweetened by a high-potency sweetener. Accordingly, reducing the amount of bulk solvent by adding water-binding components to the concentrate can slow the rate of diffusion-dependent reactions by increasing viscosity and lowering water activity. Advantageously, reduction of bulk water content also results in reduction in water activity, which can improve the microbial stability of the concentrate.

The amount of water in the concentrate will generally be within about 40 to about 98 percent. In one aspect, about 40 percent to about 90 percent water is included. In another aspect, about 40 percent to about 80 percent water is included.

The liquid concentrates described herein may include one or more flavorings. Generally about 0.5 to about 40 percent flavoring is included. Flavorings useful in the liquid concentrates described herein may include, for example, liquid flavorings (including, for example, alcohol-containing flavorings (e.g., flavorings containing ethanol, propylene glycol, 1,3-propanediol, glycerol, and combinations thereof), and flavor emulsions (e.g., nano- and micro-emulsions)) and powdered flavorings (including, for example, extruded, spray-dried, agglomerated, freeze-dried, and encapsulated flavorings). The flavorings may also be in the form of an extract, such as a fruit extract. The flavorings can be used alone or in various combinations to provide the concentrate with a desired flavor profile.

A variety of commercially-available flavorings can be used, such as those sold by Givaudan (Cincinnati, Ohio) and International Flavors & Fragrances Inc. (Dayton, N.J.). The flavorings can be included at about 0.1 percent to about 40 percent, in another aspect about 0.5 percent to about 40 percent, in another aspect about 1 percent to about 30 percent, and in another aspect about 5 to about 20 percent by weight of the concentrates. In some aspects, the precise amount of flavoring included in the composition may vary, at least in part, based on the concentration factor of the concentrate, the concentration of flavor key in the flavoring, and desired flavor profile of a final beverage prepared with the concentrate. Generally, extruded and spray-dried flavorings can be included in the concentrates in lesser amounts than alcohol-containing flavorings and flavor emulsions because the extruded and spray-dried flavorings often include a larger percentage of flavor key. Exemplary recipes for flavorings are provided in Table 2 below. Of course, flavorings with other formulations may also be used, if desired.

TABLE 2
Exemplary Flavoring Formulations

| | Propylene | Ethanol- | Flavor | | Spray- |
|---|---|---|---|---|---|
| | Glycol | Containing | Emul- | Extruded | Dried |
| | Flavorings | Flavorings | sions | Flavorings | Flavorings |
| Flavor key | 1-20% | 1-20% | 1-10% | 1-40% | 1-40% |
| Water | 0-10% | 0-10% | 70-80% | — | — |
| Ethanol | — | 80-95% | — | — | — |
| Propylene | 80-95% | — | — | 0-4% | 0-4% |
| glycol | | | | | |
| Emulsifier | — | — | 1-4% | 0.1-10% | — |
| Carrier | — | — | — | 1-95% | 1-95% |
| Emulsion | — | — | 15-20% | — | — |
| stabilizer | | | | | |
| Preservative | 0-2% | 0-2% | 0-2% | 0-2% | 0-2% |

Many flavorings include one or more non-aqueous liquids, typically in the form of propylene glycol or ethanol. When such flavorings are included in the concentrates described herein, the non-aqueous liquid content of the flavorings is included in the calculation of the total NAL content of the concentrate. For example, if a flavoring has eighty percent propylene glycol and the flavoring is included in the concentrate at an amount of thirty percent, the flavoring contributes 24 percent propylene glycol to the total non-aqueous liquid content of the concentrate.

Extruded and spray-dried flavorings often include a large percentage of flavor key and carrier, such as corn syrup solids, maltodextrin, gum arabic, starch, and sugar solids. Extruded flavorings can also include small amounts of alcohol and emulsifier, if desired. Flavor emulsions can also include carriers, such as, for example, starch. In one aspect, the flavor emulsion does not include alcohol. In other aspects, the flavor emulsion may include low levels of alcohol (e.g., propylene glycol, 1,3-propanediol, and ethanol). A variety of emulsifiers can be used, such as but not limited to sucrose acetate isobutyrate and lecithin, and an emulsion stabilizer may be included, such as but not limited to gum acacia. Micro-emulsions often include a higher concentration of flavor key and generally can be included in lesser quantities than other flavor emulsions.

In another aspect, a variety of different flavor emulsions may be included in the concentrated composition. Suitable flavor emulsions include, for example, lemon, orange oil lemonade, lemon oil lemonade, pink lemonade, floral lemonade, orange, grapefruit, grapefruit citrus punch, and lime from Givaudan (Cincinnati, Ohio). Of course, other flavor emulsions or types of emulsions, including nano- or micro-emulsions, may be used, if desired.

In another aspect, a variety of different alcohol-containing flavorings may be included in the concentrated composition. The alcohols typically used in commercially available flavorings include compounds having one or more hydroxyl groups, including ethanol and propylene glycol, although others may be used, if desired. The flavoring may also include 1,3-propanediol, if desired. Suitable alcohol-containing flavorings include, for example, lemon, lime, cranberry, apple, watermelon, strawberry, pomegranate, berry, cherry, peach, passionfruit, mango, punch, white peach tea, sweet tea, and combinations thereof. For example, flavorings from commercial flavor houses include, for example, Lemon Lime, Cranberry Apple, Strawberry Watermelon, Pomegranate Berry, Peach Mango, White Peach Tea, and Tea Sweet from International Flavors & Fragrances Inc (New York, N.Y.), as well as Peach Passionfruit and Tropical from Firmenich Inc. (Plainsboro, N.J.). Other alcohol-containing flavorings may be used, if desired.

In yet another aspect, a variety of powdered flavorings may be included in the concentrate. The form of the powdered flavorings is not particularly limited and can include, for example, spray-dried, agglomerated, extruded, freeze-dried, and encapsulated flavorings. Suitable powdered flavorings include, for example, Natural & Artificial Tropical Punch from Givaudan (Cincinnati, Ohio), Natural & Artificial Orange from Symrise (Teterboro, N.J.), and Natural Lemon from Firmenich Inc. (Plainsboro, N.J.). Other powdered flavorings may also be used, if desired.

In some approaches, the acidulant and flavoring are included at a ratio of at least about 0.1:1, i.e., with “at least” meaning increasing quantities of acidulant relative to flavoring, in another aspect at a ratio of at least about 0.5:1, in another aspect at a ratio of at least about 1:1, in another aspect at least about 1.5:1, and in yet another aspect at least about 2:1.

If desired, the liquid beverage concentrates can further include salts, preservatives, viscosifiers, surfactants, stimulants, antioxidants, caffeine, electrolytes (including salts), nutrients (e.g., vitamins and minerals), stabilizers, gums, and the like. Preservatives, such as EDTA, sodium benzoate, potassium sorbate, sodium hexametaphosphate, nisin, natamycin, polylysine, and the like can be included, if desired, but are generally not necessary for shelf stability due to the low water content. Salts can be added to the concentrate to provide electrolytes, which is particularly desirable for sports-type or health drinks. Exemplary salts include, for example, sodium citrate, mono sodium phosphate, potassium chloride, magnesium chloride, sodium chloride, calcium chloride, the like, and combinations thereof. For example, sodium lactate, or other salts, may be used to provide a nutritive source of minerals or for pH buffering. By one approach, the additional ingredients can be included in any combination and in any amount so long as the desired pH and viscosity are achieved and solubility of the remaining ingredients is maintained. The amount of the additional ingredients included may also depend on the ability to solubilize or disperse the ingredients in the concentrate.

Flavor Stability

The concentrates described herein provide enhanced flavor stability, which is particularly beneficial to very acid-labile ingredients. In some approaches, “enhanced flavor stability” and “avoiding substantial degradation of flavor” means that the concentrates described herein retain more flavor after storage at room temperature over the shelf life of the product as compared to an otherwise identical concentrate having a lower viscosity due to a difference in the amount of the viscosity increasing agent. In other approaches, “enhanced flavor stability” and “avoiding substantial degradation of flavor” means that there is little change in flavor and development of off flavor in the concentrate when stored at 70° F. in a sealed container for at least about three months, in another aspect at least about six months, and in another aspect at least about nine months, and in yet another aspect at least about twelve months. If the ingredients are light sensitive, the container should be impermeable to light. For example, the change in flavor or development of off flavor notes can be analyzed by a trained flavor panel whereby the concentrate is diluted to provide a beverage and compared to a beverage prepared from an otherwise identical freshly prepared concentrate (i.e., within 24 hours and stored at room temperature in a sealed container) or concentrate. By another approach, the change in flavor or development of off flavor notes can be analyzed by a trained flavor panel whereby the concentrate is diluted to provide a beverage and compared to a beverage prepared from an identical concentrate, preferably from the same lot or batch of product, stored in a sealed container in the frozen state throughout its shelf life and thawed at room temperature immediately prior to testing. The concentrates can be evaluated on a 10 point scale, with a score of “1” being considered identical to control, “2-5” being slightly/moderately different than control, and “above 5” being unacceptably different from control. A concentrate achieving a score of 5 or less, in another aspect 4 or less, would be considered to have acceptable flavor stability. Analytical methods may also be used to determine if flavors have oxidized or otherwise deteriorated, including for example, gas chromatography, mass spec, and HPLC.

Color and Vitamin Stability

The concentrates described herein provide enhanced stability to color ingredients and other ingredients where the degradation process includes browning (e.g., Vitamin C). As used herein, “avoiding substantial degradation” of color and vitamin ingredients is defined as a change of less than about 5 percent, in another aspect less than about 10 percent, in another aspect less than about 15 percent, and in another aspect less than about 20 percent, based on changes in L*value of the Hunter Instruments L*a*b color scale during storage at 70° F. in a sealed container for at least about three months, in another aspect at least about six months, and in another aspect at least about nine months, and in yet another aspect at least about twelve months. If the ingredients are light sensitive, the container should be impermeable to light. In one exemplary method, the product after three months of storage at 70° F. can be compared to an identical product, preferably from the same lot or batch of product, stored at freezer temperatures after manufacture and thawed at room temperature immediately prior to testing.

The colors can include artificial colors, natural colors, or a combination thereof and can be included in the range of 0 to about 15 percent, in another aspect about 0.001 to 10 percent, in another aspect about 0.005 to 5 percent, and in yet another aspect in the range of about 0.005 to 1 percent, if desired. In formulations using natural colors, a higher percent by weight of the color may be needed to achieve desired color characteristics. Exemplary colors include natural beet juice powder, betalain, and annatto.

It has been found that the stability of colors, particularly natural colors, can be enhanced in the increased viscosity formulations provided herein as compared to an otherwise similarly concentrated composition having a lower viscosity. The stability of the color can be quantified as measured on the Hunter Instruments L*a*b color scale. The L*a*b scale describes the color of a sample in terms of three color variables. The “L” scale represents the tint of a sample on a scale of 0 to 100, with a value of 100 representing white and a value of zero representing black. The “a” scale is a measure of the relative amount of green or red light reflected by the sample, with positive “a” values representing increasing intensity of red and negative “a” values representing increasing intensity of green. The “b” scale is a measure of the relative amount of blue or yellow light reflected by the sample, with positive values representing increasing intensity of yellow and negative values indicating increasing intensity of blue. The various types of colors generally degrade at different rates, but the stability of a particular color can be analyzed, for example, over a period of time at room temperature in the concentrates described herein in comparison to an otherwise identically formulated concentrate having lower viscosity.

The stability of Vitamin C can also be measured this way. As described in more detail later, Vitamin C (ascorbic acid) is known to degrade and brown when solvated in an acidic solution. Therefore, the onset of browning can be measured on the Hunter Instruments L*a*b color scale, particularly as indicated by a decrease in the L* value. The stability of Vitamin C can also be measured by titration, if desired.

Incorporation into Food and Beverages

The concentrates described herein can also be added to potable liquids to form flavored beverages. In some aspects, the concentrate may be non-potable (such as due to the high acid content and intensity of flavor). For example, the beverage concentrate can be used to provide flavor to water, cola, carbonated water, tea, coffee, seltzer, club soda, the like, and can also be used to enhance the flavor of juice. In one aspect, the beverage concentrate can be used to provide flavor to alcoholic beverages, including but not limited to flavored champagne, sparkling wine, wine spritzer, cocktail, martini, or the like.

The concentrates described herein can be combined with a variety of food products to add flavor to the food products. For example, the concentrates described herein can be used to provide flavor to a variety of solid, semi-solid, and liquid food products, including but not limited to oatmeal, cereal, yogurt, strained yogurt, cottage cheese, cream cheese, frosting, salad dressing, sauce, and desserts such as ice cream, sherbet, sorbet, and Italian ice. Appropriate ratios of the beverage concentrate to food product or beverage can readily be determined by one of ordinary skill in the art.

Packaging

In one aspect, various quantities of the liquid beverage concentrates may be packaged in containers depending on the desired number of servings in the container. For example, more highly concentrated products may be packaged in smaller quantities while still delivering the same number of servings as a lesser concentrated product in a larger package. For example, a highly concentrated product could be packaged in the amount of about 0.5 to about 6 oz. of concentrate, in another aspect of about 1 to about 4 oz., and in another aspect about 1 to about 2 oz., with said quantity being sufficient to make at least about 10 eight oz. servings of flavored beverage. Lesser concentrated products could be packaged in larger amounts, such as about 10 to about 30 ounces to make at least about 10 eight oz. servings of flavored beverage. Of course, larger or smaller quantities may be packaged as needed.

Advantages and embodiments of the liquid concentrate described herein are further illustrated by the following examples; however, the particular conditions, processing schemes, materials, and amounts thereof recited in these examples, as well as other conditions and details, should not be construed to unduly limit the compositions and methods described herein. All percentages in this application are by weight unless otherwise indicated.

### EXAMPLES

The following examples further illustrate various features of the concentrates described herein but are not intended to limit the scope as set forth in the appended claims.

### Example 1

This Example demonstrates the slowing of the rate of natural color degradation via an increase in viscosity through addition of gums that have little or no effect on the volume of bulk solvent in the composition. A control and experimental sample were prepared according to the formulations provided in Table 3 and then stored in a 70° F., light-free environment.

TABLE 3

| | Control Sample | Experimental Sample |
|---|---|---|
| | (No Gums) | (With Gums) |
| Water | 65.14 | 63.86 |
| Citric Acid | 30.00 | 30.00 |
| Red Beet Juice Powder | 2.86 | 2.86 |
| Potassium-Citrate | 2.00 | 2.00 |
| Xanthan Gum | 0.00 | 1.28 |
| (Ketrol-F [CP KELCO]) | | |
| Total Weight | 100.00 | 100.00 |
| Water Activity (Aw) | 0.948 | 0.940 |
| Viscosity (cP) at 50 rpm | 4.74 | 4140 |
| Viscosity (cP) at 100 rpm | 4.74 | 2400 |

The L*a*b Values of each sample were tested at days 1, 4, 5, and 6 and compared to each sample's L*a*b values at time zero. The percent change in the “a” value and Delta-E Value of the control sample was compared to the “a” value and Delta-E Value of the experimental sample. The results are provided in Table 4 below.

TABLE 4
L*a*b Values of Control and Experimental Samples on Days 0-6.

| | | | | | | Y | Delta Descriptor- | dE | dE CMC | Metameris | Yield of |
|---|---|---|---|---|---|---|---|---|---|---|---|
| Product | Storage | Day | L* | a* | b* | Transmission | Rectangular | CMC | (l:c ) | m Index | a*-Value |
| Control | Frozen | 0 | 94.09 | 10.3 | −3.95 | 85.48 | | | | | N/A |
| | 70° F. | 1 | 94.3 | 10.1 | −4.13 | 85.97 | Lighter, less red, bluer | 0.28 | 2.00:1.00 | 0.06 | 98.06% |
| | 70° F. | 4 | 96.18 | 6.53 | −2.28 | 90.45 | Lighter, less red, less | 3.38 | 2.00:1.00 | 0.85 | 63.40% |
| | | | | | | | blue | | | | |
| | 70° F. | 5 | 96.29 | 6.33 | −2.2 | 90.72 | Lighter, less red, less | 3.55 | 2.00:1.00 | 0.89 | 61.46% |
| | | | | | | | blue | | | | |
| | 70° F. | 6 | 97.15 | 4.59 | −0.83 | 92.8 | Lighter, less red, less | 5.39 | 2.00:1.00 | 1.28 | 44.56% |
| | | | | | | | blue | | | | |
| 1.28% | Frozen | 0 | 93.46 | 11.11 | −4.09 | 84.02 | | | | | N/A |
| Xanthan | 70° F. | 1 | 93.53 | 11.16 | −4.55 | 84.19 | Lighter, redder, bluer | 0.46 | 2.00:1.00 | 0.09 | 100.45% |
| | 70° F. | 4 | 95.4 | 7.62 | −2.58 | 88.56 | Lighter, less red, | 3.03 | 2.00:1.00 | 0.77 | 68.59% |
| | | | | | | | less blue | | | | |
| | 70° F. | 5 | 95.34 | 7.76 | −2.73 | 88.43 | Lighter, less red, less | 2.88 | 2.00:1.00 | 0.74 | 69.85% |
| | | | | | | | blue | | | | |
| | 70° F. | 6 | 96.1 | 6.28 | −1.42 | 90.25 | Lighter, less red, less | 4.44 | 2.00:1.00 | 1.07 | 56.53% |
| | | | | | | | blue | | | | |

It was found that after 6 days of storage, the “a” value of the control sample decreased from 10.3 to 4.59, whereas the “a” value of the experimental sample decreased at a slower rate from 11.11 to only 6.28.

The slower rate of color degradation in the experimental sample was attributed to the inclusion of xanthan gum and resulting increased viscosity of the concentrate. It is not believed that the slower rate of color degradation was due to changes in water activity or the amount of bulk solvent (i.e., the amount of solvent available for components to diffuse through).

Additionally, the L*a*b values of the control samples were compared to those of the experimental sample at each of days 1 to 6. The results are provided in Table 5 below.

TABLE 5
L*a*b Values and Pass/Fail of Control and Experimental Samples (1.28% Xanthan) on Days 0-6.

| | | | | | | | Delta | | dE | |
|---|---|---|---|---|---|---|---|---|---|---|
| | | | | | | Y | Descriptor- | dE | CMC | Metameric |
| Product | Storage | Day | L* | a* | b* | Transmission | Rectangular | CMC | (l:c ) | m Index |
| 1.28% Xanthan | * | 0 | 93.46 | 11.11 | −4.09 | 84.02 | | | | |
| Control (No | * | 0 | 94.09 | 10.3 | −3.95 | 85.48 | Lighter, less | 0.68 | 2.00: | 0.18 |
| Xanthan) | | | | | | | red, less blue | | 1.00 | |
| 1.28% Xanthan | 70° F. | 1 | 93.53 | 11.16 | −4.55 | 84.19 | | | | |
| Control (No | 70° F. | 1 | 94.3 | 10.1 | −4.13 | 85.97 | Lighter, less | 0.92 | 2.00: | 0.24 |
| Xanthan) | | | | | | | red, less blue | | 1.00 | |
| 1.28% Xanthan | 70° F. | 4 | 95.4 | 7.62 | −2.58 | 88.56 | | | | |
| Control (No | 70° F. | 4 | 96.18 | 6.53 | −2.28 | 90.45 | Lighter, less | 1.06 | 2.00: | 0.25 |
| Xanthan) | | | | | | | red, less blue | | 1.00 | |
| 1.28% Xanthan | 70° F. | 5 | 95.34 | 7.76 | −2.73 | 88.43 | | | | |
| Control (No | 70° F. | 5 | 96.29 | 6.33 | −2.2 | 90.72 | Lighter, less | 1.41 | 2.00: | 0.33 |
| Xanthan) | | | | | | | red, less blue | | 1.00 | |
| 1.28% Xanthan | 70° F. | 6 | 96.1 | 6.28 | −1.42 | 90.25 | | | | |
| Control (No | 70° F. | 6 | 97.15 | 4.59 | −0.83 | 92.8 | Lighter, less | 1.81 | 2.00: | 0.4 |
| Xanthan) | | | | | | | red, less blue | | 1.00 | |

As shown in Table 5, there was no significant difference between the initial (day 0) and day 1 samples. More specifically, the delta-E values were less than 1 and were 0.68 and 0.92, respectively. On day 4, the difference between the control and experimental samples was significant. In particular, the delta-E value was 1.06. The significance of the delta-E value progressively increased and on days 5 and 6, the delta-E values were 1.41 and 1.81, respectively. This indicates that on days 4, 5, and 6 that the 1.28% xanthan sample was significantly different visually than the control. A delta-E value greater than 1 indicates that the optical difference between two samples may be observed by the naked eye.

Overall, it was observed that, after day 1, the rate of degradation of the control sample was significantly higher than the rate of degradation of the experimental sample. It was also observed that although the initial rates of degradation of the control sample and the experimental sample were similar, the rate of degradation of the control samples became significantly faster over time compared to the rate of degradation of the experimental sample.

Xanthan gum has a high polymer volume ratio (Rv) due to its high molecular weight and its low-degree of branching. The high Rv value of xanthan gum enables it to “trap” water that it is not chemically or physically bound to the xanthan gum, meaning that the water within the “spinning,” solvated xanthan gum is free to bind to other chemicals or molecules within the “spinning” gum. Rv is the polymer volume ratio (Rv=Vsphere/Vpolymer).

It was initially assumed that the “trapped” solution should have the same degree of diffusion within the effective volume as it would outside the effective volume. It was found that xanthan gum does not bind water and other solvated components directly and increases the viscosity without lowering the water activity. It was found that there was essentially the same amount of “bulk” (free) water with and without xanthan gum in the sample, and xanthan gum appeared to only bind whatever water it was directly associated with. This caused a minimal drop in the amount of “bulk” water in solution but caused a significant change in the viscosity.

In terms of the red beet juice powder used as the natural colorant, it was assumed that the colorant should degrade at the same rate with or without xanthan gum in solution. This assumption was made due to the acid and the color freely diffusing inside of the “trapped” volume. However, as discussed above, it was surprisingly found that the xanthan gum slowed the colorant's rate of degradation when compared to a sample free of xanthan gum.

### Example 2

In this Example, it was demonstrated that the rate of oxidation of lemon flavor was slowed by replacing a portion of the solvent (water) with more viscous solvents that have little or no effect on “bulk” solvent volume.

Lemon-flavored beverage concentrates were prepared containing solvent systems of (1) water, (2) water with ethanol, or (3) water with propylene glycol. The rate of lemon flavor oxidation and hydrolysis were observed by a sensory panel. The formulations of the concentrates are shown in Tables 6 and 7 below.

TABLE 6
Formulations of Concentrated Flavor Compositions
Having Low Water Content Using Propylene Glycol

| | 5% | | | | | 64% |
|---|---|---|---|---|---|---|
| | Water | 10% Water | 15% Water | 25% Water | 35% Water | Water |
| Ingredients | (Sample 1) | (Sample 2) | (Sample 3) | (Sample 4) | (Sample 5) | (Sample 6) |
| Water | 5.0% | 10.0% | 15.0% | 25.0% | 35.0% | 64.0175% |
| Propylene | 59.0675% | 54.0675% | 49.0675% | 39.0675% | 29.0675% | 0% |
| glycol | | | | | | |
| Citric acid | 22.4% | 22.4% | 22.4% | 22.4% | 22.4% | 22.4% |
| Potassium | 0.6% | 0.6% | 0.6% | 0.6% | 0.6% | 0.6% |
| citrate | | | | | | |
| Lemon | 11.48% | 11.48% | 11.48% | 11.48% | 11.48% | 11.48% |
| Sicilian | | | | | | |
| Generessence | | | | | | |
| Flavoring | | | | | | |
| (from IFF) | | | | | | |
| Sucralose | 1.4204% | 1.4204% | 1.4204% | 1.4204% | 1.4204% | 1.4204% |
| (dry) | | | | | | |
| EDTA | 0.0321% | 0.0321% | 0.0321% | 0.0321% | 0.0321% | 0.0321% |
| Potassium | 0% | 0% | 0% | 0% | 0% | 0.05% |
| sorbate | | | | | | |
| Total | 100.0 | 100.0 | 100.0 | 100.0 | 100.0 | 100.0 |

TABLE 7
Formulations of Concentrated Flavor Compositions
Having Low Water Content using Ethanol.

| | High Water | | | | | |
|---|---|---|---|---|---|---|
| | Comparative | | | | | |
| | Sample | 5% Water | 10% Water | 15% Water | 25% Water | 35% Water |
| Water | 64.0175 | 5.0 | 10.0 | 15.0 | 25.0 | 35.0 |
| Ethanol | 0 | 58.3679 | 53.3679 | 48.3679 | 38.3679 | 28.3679 |
| Citric acid | 22.4 | 22.4 | 22.4 | 22.4 | 22.4 | 22.4 |
| Potassium | 0.6 | 0.6 | 0.6 | 0.6 | 0.6 | 0.6 |
| citrate | | | | | | |
| Lemon | 11.48 | 11.48 | 11.48 | 11.48 | 11.48 | 11.48 |
| Sicilian | | | | | | |
| Generessence | | | | | | |
| Flavoring | | | | | | |
| (from IFF) | | | | | | |
| Sucralose | 1.4204 | 1.4204 | 1.4204 | 1.4204 | 1.4204 | 1.4204 |
| (dry) | | | | | | |
| EDTA | 0.0321 | 0.0321 | 0.0321 | 0.0321 | 0.0321 | 0.0321 |
| Potassium | 0.05 | 0 | 0 | 0 | 0 | 0 |
| sorbate | | | | | | |
| Total | 100.0 | 100.0 | 100.0 | 100.0 | 100.0 | 100.0 |

It was found that solvent systems containing a mixture of water/ethanol or water/propylene glycol outperformed the single-solvent water systems in slowing of the degradation rate. The degree of outperformance was enhanced when the solvent system contained less water and more ethanol or propylene glycol. It was also found that the water and propylene glycol solvent system outperformed the water and ethanol systems, especially as the amount of water in these solvent systems was decreased and replaced by ethanol or propylene glycol.

Accordingly, it appears that the addition of propylene glycol or ethanol into the beverage concentrate with decreased water content appears to cause a reduction in the amount of dissociated acid, which effectively reduces the amount of hydrogen ions that can cause acid-catalyzed flavor hydrolysis.

A secondary effect that was observed was how an increase in viscosity decreases the rate of acid-catalyzed hydrolysis and oxidation. Essentially the same amount of bulk solvent was present in all three systems. More specifically, whether the system included water, ethanol, or propylene glycol, there was approximately the same amount of unbound solvent that beverage components could diffuse through. This secondary effect appeared to outweigh the impact of ethanol and propylene glycol limiting the dissociation of acid and is discussed below with reference to Table 8.

TABLE 8
pH and Viscosity for Low Water Lemon Concentrates
in Ethanol and Propylene Glycol

| | Water with Ethanol | | | Water with Propylene Glycol | | |
|---|---|---|---|---|---|---|
| | | | Time to | | | Time to |
| | | | Failure | | | Failure |
| Water | | Viscosity | stored | | Viscosity | stored |
| % | pH | (cP)* | at 90° F. | pH | (cP) | at 90° F. |
| 5 | 2.56 | 5.30 | 12-weeks | 2.43 | 155.00 | Passed for |
| | | | | | | 12 weeks |
| 10 | 2.64 | 7.20 | 10-weeks | 2.33 | 114.00 | Passed for |
| | | | | | | 12 weeks |
| 15 | 2.59 | 7.55 | 6-weeks | 2.26 | 73.20 | Passed for |
| | | | | | | 12 weeks |
| 25 | 2.41 | 7.68 | 4-weeks | 2.12 | 37.40 | 6-weeks |
| 35 | 2.20 | 7.74 | 4-weeks | 1.94 | 20.00 | 6-weeks |
| 63 | 1.71 | 4.03 | 2-weeks | 1.76 | 4.54 | 2-weeks |

*Viscosity read using a Brookfield DV-II + Pro viscometer, spindle #SOO @ 500 rpm.

As can be seen in Table 8 above, the 5% water with ethanol sample had a higher pH than the 5% water with propylene glycol sample. If limiting the rate of hydrolysis and oxidation solely depended on acid dissociation, it would have been expected that the ethanol sample would have outperformed the propylene glycol sample. However, it was observed that the 5%, 10%, and 15% water with propylene glycol samples had a longer shelf life than the 5%, 10%, and 15% water with ethanol samples. This outperformance appeared to be due to the propylene glycol samples having a significantly higher viscosity than the ethanol samples. For example, the 5% water with ethanol sample and the 5% water with propylene glycol sample had viscosities of 5.30 cP and 155.00 cP, respectively.

### Example 3

This Example demonstrates the slowing of acid-catalyzed flavor hydrolysis and oxidation through the addition of water-binding components that lower water activity (amount of “bulk” solvent) and increase viscosity.

Two 7× beverage concentrates were made according to the recipes of Table 9 below: (1) a control including, in pertinent part, lemon flavor, sucralose, but no sucrose; and (2) an experimental sample including, in pertinent part, lemon flavor and sucrose (but no sucralose).

TABLE 9
Liquid Beverage Concentrate Formulations

| | Experimental | Control |
|---|---|---|
| | (High Viscosity, | (Low Viscosity, |
| | Low Water | High Water |
| | Activity) | Activity) |
| | (% by wt) | (% by wt) |
| Water | 51.07920 | 96.5596 |
| Sucrose | 45.15 | 0 |
| Potassium Sorbate | 0.05 | 0.05 |
| Potassium citrate | 0 | 0.25 |
| Sodium citrate | 0.20000 | 0 |
| Givaudan Natural Lemon Flavor | 1.2 | 1.2 |
| Emulsion | | |
| Sucralose Liquid | 0 | 0.5 |
| Yellow#5 | 0.0008 | 0.0004 |
| Citric Acid | 2.25000 | 1.425 |
| Sodium benzoate | 0.05 | 0 |
| Sodium metabisulfite | 0.005 | 0 |
| Rosemary Extract | 0.015 | 0.015 |
| Total Sum: | 100 | 100 |
| Viscosity (@ 20 C.) [Spindle | 16.6 cP | 3.46 cP |
| #S00, 20 rpm] | | |
| Water Activity | 0.895 | 0.995 |
| pH | 2.46 | 2.70 |

It was observed that the control sample, which had lower viscosity and higher water activity, oxidized to an unacceptable level after being stored at 90° F. for 4 weeks. Conversely, the experimental sample, which had higher viscosity and lower water activity, did not oxidize to a level that was considered unacceptable after 12 weeks of storage at 90° F. Also, it should be noted that the experimental sample had a higher acid concentration and lower pH versus the control sample which would have been expected to increase the rate of degradation. Each sample was subsequently used to provide a beverage by diluting 1 part concentrate in 6 parts water.

While the experimental sample had both a lower water activity and higher viscosity when compared to the control, the reduction in water activity was not believed to be significant enough to cause a decreased rate of oxidation. It is known by those skilled in the art that rates of chemical reactions such as lipid oxidation and non-enzymatic browning are not significantly reduced at a water activity around 0.895 or higher. It is known that the rate of chemical reactions do not significantly slow until water activity is reduced below approximately 0.7. Therefore, it appears that the increase in viscosity, and not decreased water activity, due to addition of sucrose resulted in the decreased rate of lemon flavor oxidation.

### Example 4

This example demonstrates the rate of (1) Vitamin C degradation and (2) browning due to Vitamin C can be slowed through an increase in viscosity of the solution solvating the Vitamin C. The increase in viscosity was attained via an addition of gums or an addition of a bulk sweetener such as glucose. All samples in this example were prepared at 70° F. via simple agitation and then stored at 70° F. in a light-free environment.

Vitamin C (ascorbic acid) is known to degrade and brown when solvated in an acidic solution. It is believed that early breakdown products of Vitamin C still have functionality. Unlike other vitamins used to fortify beverages, Vitamin C can brown the beverage while not losing all functionality. Therefore, assessing the browning of Vitamin C appears to be a suitable way to evaluate Vitamin C functionality during the shelf-life of the beverage.

Part A:

In the first part of the experiment, samples were prepared according to Table 10 below which lack Vitamin C to show that little to no browning occurs in the absence of Vitamin C. The samples were prepared at 70° F. via simple agitation and then stored at 70° F. in a light-free environment. Viscosity was measured at 10 rpm at 20° C. using spindle #S00 with a Brookfield viscometer.

TABLE 10
Composition of Control and Variant Samples.

| | Vitamin C | Vitamin C | Vitamin C |
|---|---|---|---|
| | Free | Free with | Free with |
| | Control | 0.08% Xanthan | 0.32% Xanthan |
| | (%/wt.) | (%/wt.) | (%/wt.) |
| Water | 70.14 | 70.06 | 69.82 |
| Xanthan Gum | 0.00 | 0.08 | 0.32 |
| Citric Acid | 16.50 | 16.50 | 16.50 |
| Malic Acid | 4.12 | 4.12 | 4.12 |
| Potassium | 1.50 | 1.50 | 1.50 |
| Citrate | | | |
| Acesulfame | 0.84 | 0.84 | 0.84 |
| Potassium | | | |
| Sucralose 25% | 6.85 | 6.85 | 6.85 |
| Solution | | | |
| Potassium Sorbate | 0.05 | 0.05 | 0.05 |
| Total Sum: | 100 | 100 | 100 |
| pH | 2.12 | 2.11 | 2.13 |
| Viscosity (cP) | 4 | 35 | 200 |

After 8 months of storage, the L*a*b values of the three samples were measured. Based on the L*a*b values of the Table 11, it was found that the long-term solvation of xanthan gum, citric acid, sucralose, malic acid, acesulfame potassium and potassium sorbate in Water at most caused an insignificant amount of browning.

TABLE 11
L*a*b values of Composition of Control and Variant Samples after
8 months of storage in a 70 F., light-free environment.

| | Months | | | | Y |
|---|---|---|---|---|---|
| | Storage | | | | Trans- |
| Sample | at 70° F. | L* | a* | b* | mission |
| Vitamin C Free Control | 8 | 99.84 | −0.25 | 1.46 | 99.59 |
| Vitamin C Free with | 8 | 100.03 | −0.18 | 0.76 | 100.07 |
| 0.08% Xanthan | | | | | |
| Vitamin C Free with | 8 | 99.6 | −0.21 | 1.22 | 98.96 |
| 0.32% Xanthan | | | | | |

Part B:

In the second part of the experiment, samples were prepared that include Vitamin C according to Table 12 below. Viscosity was measured using a Brookfield DV-II+Pro viscometer using spindle #S00 at 10 rpm and 50 rpm. The pH and viscosity measurements were performed on the undiluted, concentrated samples at 20° C.

TABLE 12
Composition of Control and Variant Samples

| | | | | Variant 2 | | Variant 4 | Variant | Variant 6 |
|---|---|---|---|---|---|---|---|---|
| | | Control | Variant 1 | (0.08% | Variant 3 | (0.32% | 5 | (20% |
| | | with | (0.08% | Xanthan | (0.32% | Xanthan | (20% | Glucose |
| | Control | EDTA | Xanthan) | with EDTA) | Xanthan) | with EDTA) | Glucose) | with EDTA) |
| Water | 68.33% | 68.33% | 68.25% | 68.25% | 68.01% | 68.01% | 48.33% | 48.33% |
| Citric Acid | 16.48% | 16.48% | 16.48% | 16.48% | 16.48% | 16.48% | 16.48% | 16.48% |
| Potassium | 0.05% | 0.05% | 0.05% | 0.05% | 0.05% | 0.05% | 0.05% | 0.05% |
| Sorbate | | | | | | | | |
| Potassium | 1.50% | 1.50% | 1.50% | 1.50% | 1.50% | 1.50% | 1.50% | 1.50% |
| Citrate | | | | | | | | |
| Sucralose | 6.85% | 6.85% | 6.85% | 6.85% | 6.85% | 6.85% | 6.85% | 6.85% |
| 25% | | | | | | | | |
| Solution | | | | | | | | |
| Malic Acid | 4.12% | 4.12% | 4.12% | 4.12% | 4.12% | 4.12% | 4.12% | 4.12% |
| Acesulfame | 0.84% | 0.84% | 0.84% | 0.84% | 0.84% | 0.84% | 0.84% | 0.84% |
| Potassium | | | | | | | | |
| Vitamin C | 1.83% | 1.83% | 1.83% | 1.83% | 1.83% | 1.83% | 1.83% | 1.83% |
| Glucose | 0% | 0% | 0% | 0% | 0% | 0% | 20.0% | 20.0% |
| Xanthan | 0% | 0% | 0.08% | 0.08% | 0.32% | 0.32% | 0% | 0% |
| Gum | | | | | | | | |
| EDTA | 0.0000% | 0.0025% | 0% | 0.0025% | 0% | 0.0025% | 0% | 0.0025% |
| Total Sum: | 100.00 | 100.00 | 100.00 | 100.00 | 100.00 | 100.00 | 100.00 | 100.00 |
| pH | 2.12 | | 2.13 | | 2.12 | | 2.12 | |
| Viscosity (cP) | 4 | | 35 | | 200 | | 14 | |
| at 10 rpm | | | | | | | | |
| Viscosity (cP) | 4 | | 21 | | 100 | | 14 | |
| at 50 rpm | | | | | | | | |

The percent of Vitamin C remaining in the control and experimental samples was measured at 0, 4, 8, and 11 weeks after storage at 70° F. in a light free environment. Samples were diluted with water to an expected level of 150 ppm Vitamin C prior to measurement. The results are presented in Table 13 below.

TABLE 13
Percent of Vitamin C Remaining After Storage

| | Control | Variant 1 | Variant 3 | Variant 5 |
|---|---|---|---|---|
| Time Zero | 100.07% | 100.00% | 99.60% | 100.53% |
| Week 4 | 93.32% | 98.65% | 97.59% | 97.32% |
| Week 8 | 83.46% | 93.99% | 89.32% | 91.19% |
| Week 11 | 82.66% | 89.32% | 86.66% | 85.32% |

It was found that the addition of xanthan gum or glucose slowed the rate of Vitamin C deterioration through 11 weeks of storage. It was found that after 11 weeks of storage the Control sample had an approximate yield of 83% compared to yields of 89%, 87%, and 85% in Variant 1 (0.08% Xanthan), Variant 3 (0.32% xanthan), and Variant 5 (20% Glucose), respectively.

Thus, the inclusion of xanthan gum or glucose in the experimental samples appeared to slow the rate of Vitamin C deterioration as a result in the change of viscosity. As can be seen in Table 12 above, the inclusion of xanthan gum or glucose did not impact the pH of any samples.

Additionally, the L*a*b values of the control and experimental samples (in undiluted concentrate form) are provided in Table 14 below.

TABLE 14
L*a*b values of Control and Experimental samples
after 0, 4, 5, 6, 7, 9, and 11 weeks of storage.

| | Weeks | | | | |
|---|---|---|---|---|---|
| | Storage | | | | Y |
| Sample | at 70° F. | L* | a* | b* | Transmission |
| Control | 0 | 99.22 | −0.08 | 0.53 | 98 |
| | 4 | 95.78 | −5.11 | 30.95 | 89.47 |
| | 5 | 92.92 | −3.57 | 46.92 | 82.78 |
| | 6 | 89.78 | −0.46 | 56.74 | 75.83 |
| | 7 | 85.88 | 4.61 | 68.1 | 67.75 |
| | 9 | 76.21 | 17.37 | 85.49 | 50.23 |
| | 11 | 68.14 | 27 | 92.23 | 38.16 |
| Control | 4 | 99.13 | −2.61 | 9.73 | 97.78 |
| with EDTA | 5 | 97.94 | −3.47 | 17.04 | 94.77 |
| | 6 | 96.73 | −3.64 | 23.14 | 91.77 |
| | 7 | 94.67 | −2.97 | 32.77 | 86.83 |
| | 11 | 81.58 | 9.84 | 70.28 | 59.52 |
| Variant - | 0 | 99.02 | −0.04 | 0.66 | 97.5 |
| 0.08% Xanthan | 4 | 97.96 | −3.72 | 15.57 | 94.81 |
| | 5 | 95.84 | −4.52 | 30.33 | 89.62 |
| | 6 | 93.78 | −3.63 | 39.36 | 84.77 |
| | 7 | 90.64 | −0.81 | 50.81 | 77.7 |
| | 9 | 82.48 | 8.77 | 72.01 | 61.19 |
| | 11 | 75.14 | 17.82 | 83.2 | 48.5 |
| Variant - | 4 | 99.37 | −1.69 | 6.03 | 98.38 |
| 0.08% Xanthan and | 5 | 98.76 | −2.35 | 10.24 | 96.83 |
| EDTA | 6 | 97.8 | −2.83 | 15.13 | 94.41 |
| | 7 | 96.59 | −2.82 | 21.56 | 91.44 |
| | 11 | 87.65 | 3.33 | 52 | 71.34 |
| Variant - | 0 | 99.28 | −0.09 | 0.77 | 98.14 |
| 0.32% Xanthan | 4 | 96.64 | −3.83 | 18.1 | 91.55 |
| | 5 | 94.97 | −4.09 | 27.79 | 87.54 |
| | 6 | 93.35 | −3.63 | 35.95 | 83.76 |
| | 7 | 90.46 | −1.32 | 47.33 | 77.31 |
| | 9 | 83.4 | 6.91 | 67.78 | 62.92 |
| | 11 | 76.39 | 15.68 | 80.03 | 50.52 |
| Variant - | 4 | 97.72 | −2.01 | 8.57 | 94.21 |
| 0.32% Xanthan and | 5 | 97.06 | −2.52 | 13.18 | 92.58 |
| EDTA | 6 | 96.15 | −2.83 | 18.1 | 90.38 |
| | 7 | 94.71 | −2.62 | 25.14 | 86.94 |
| | 11 | 85.88 | 4.47 | 54.8 | 67.75 |
| Variant - | 0 | 100.1 | −0.05 | 0.32 | 100.29 |
| 20% Glucose | 4 | 98.9 | −3.02 | 11.99 | 97.18 |
| | 5 | 97.59 | −3.76 | 20.59 | 93.91 |
| | 6 | 96.08 | −3.55 | 27.49 | 90.19 |
| | 7 | 93.82 | −2.29 | 36.98 | 84.85 |
| | 9 | 87.57 | 3.52 | 56.31 | 71.17 |
| | 11 | 80.95 | 10.9 | 70.03 | 58.39 |
| Variant - | 4 | 99.37 | −1.95 | 7.41 | 98.37 |
| 20% Glucose and | 5 | 98.57 | −2.48 | 12.29 | 96.34 |
| EDTA | 6 | 97.67 | −2.77 | 17.33 | 94.09 |
| | 7 | 96.15 | −2.5 | 24.71 | 90.36 |
| | 11 | 86.52 | 5.02 | 56.42 | 69.03 |

It was found that the addition of xanthan gum or glucose slowed the rate of browning from Vitamin C through 11 weeks of storage. From the L*a*b values listed in Table 11 above, it is known that the long-term solvation of xanthan gum, citric acid, sucralose, malic acid, acesulfame potassium and potassium sorbate in water at most caused an insignificant amount of browning, leaving Vitamin C as the most probable cause of browning.

After 11 weeks of storage, the L*a*b values for the control were 68.14, 27, and 92.23, respectively after their initial values of 99.22. −0.08, and 0.53, respectively, at time zero. It was found, after 11 weeks of storage, the L*a*b values for the Variant 1 (0.08% xanthan) were 75.14, 17.82, and 83.2 respectively after their initial values of 99.02. −0.04, and 0.66, respectively, at time zero. The differences in the L*a*b values between the control and Variant 1 were 7.00, 9.18, and 9.03, respectively, which correspond to Variant 1 being clearer, less yellow, and less red than the control.

After 11 weeks of storage, the differences in the L*a*b values between the control and Variant 3 (0.32% xanthan) were 8.25, 11.32, and 12.20, respectively, which correspond to Variant 3 being clearer, less yellow, and less red than the control.

After 11 weeks of storage, the differences in the L*a*b values between the control and Variant 5 (20% Glucose) were 12.81, 16.10, and 22.20, respectively, which correspond to Variant 5 being clearer, less yellow, and less red than the control.

After 11 weeks of storage, the L*a*b values for Variant 2 (0.08% xanthan with EDTA) were 87.65, 3.33, and 52, respectively. The difference in the L*a*b values between the control with EDTA and Variant 2 were 6.07, 6.51, and 18.28, respectively, which correspond to Variant 2 being clearer, less yellow, and less red than the control with EDTA.

After 11 weeks of storage, the difference in the L*a*b values between the control with EDTA and Variant 4 (0.32% xanthan with EDTA) were 4.30, 5.37, and 15.48, respectively, which correspond to Variant 4 being clearer, less yellow, and less red than the control with EDTA.

After 11 weeks of storage, the difference in the L*a*b values between the control with EDTA and Variant 6 (20% Glucose with EDTA) were 4.94, 4.82, and 13.86, respectively, which correspond to Variant 6 being clearer, less yellow, and less red than the control with EDTA.

The L*a*b values of Variants 1-6 demonstrate that the Variant samples had undergone less browning than the controls. Thus, the inclusion of xanthan gum or glucose in the experimental samples appeared to slow the rate of browning from Vitamin C as a result in the change of viscosity. The inclusion of EDTA was not necessary for xanthan gum or glucose to slow the rate of browning from Vitamin C but a coupling effect was observed. EDTA, glucose, or xanthan gum each individually were effective at slowing the rate of browning, but the inclusion of EDTA with xanthan gum or glucose were able to more significantly slow the rate of browning.

### Example 5

This example demonstrates slowing the rate of flavor deterioration and oxidation through the addition of water-binding components (coconut water concentrate) that increase the viscosity of the beverage concentrate solution. Coconut water is extracted from coconuts and can be further concentrated through the removal of water and possibly the removal of fiber. Coconut water is not extracted from the meat of the coconut (this would be referred to as coconut cream). Coconut water is the free-standing, unbound water inside a coconut. This ingredient can be purchased through multiple juice suppliers.

Two 90× beverage concentrates were made according to the formulations in Table 15 below. Viscosity was measured using a Brookfield DV-II+Pro viscometer using spindle #SOO at 10 rpm. The pH and viscosity measurements were performed on the undiluted, concentrated samples at 20° C. The beverage concentrates were stored at 70° F. and 90° F.

TABLE 15
Composition of Control and Experimental
Samples with pH and viscosity

| | Control | Experimental |
|---|---|---|
| | Sample | Sample |
| | % Weight | % Weight |
| Water | 72.99 | 39.24 |
| 60 Brix | 0.00 | 33.75 |
| Coconut Water Concentrate | | |
| Acidified with Citric Acid (pH 3.8 to | | |
| about 4.2) | | |
| Malic Acid | 13.50 | 13.50 |
| Sucralose Solution (25%) | 5.57 | 5.57 |
| Tropical Punch Flavor (Propylene Glycol | 4.13 | 4.13 |
| Based) | | |
| Citric Acid | 1.58 | 1.58 |
| Potassium Citrate | 1.35 | 1.35 |
| Yellow 5 | 0.08 | 0.08 |
| Red 40 | 0.07 | 0.07 |
| Acesulfame Potassium | 0.69 | 0.69 |
| Potassium Sorbate | 0.05 | 0.05 |
| Total Sum | 100 | 100 |
| Viscosity (cP) | 10.5 | 2 |
| pH | 2.54 | 2.53 |

The concentrates were diluted (1 part concentrate to 89 parts water) to prepare beverages before the beverages were analyzed by a team of panelists. Tastings were performed at weeks 6, 8, 10, and 12 for the samples stored at 70° F. and 90° F. In addition, for the samples stored at 70° F., tastings were also performed at months 5, 7, and 9. A minimum of 5 panelists compared the degree of difference of flavor oxidation and deterioration. The samples were tasted blind and the degree of difference of the control and experimental sample was compared to their own sample, frozen at time zero and thawed prior to tasting. The scale for degree of difference was as followed: 1=no difference; 2 to 5=acceptable difference; and 6 to 10=unacceptable difference. The results are presented below in Table 16.

It was observed that after 12 weeks of storage at 90° F. and 9 months of storage at 70° F., less flavor deterioration and oxidation occurred in the experimental sample containing coconut water concentrate.

TABLE 16
Degree of Difference of Control and Experimental
Sample through 9 Months of Storage at 70°
F. and 12 Weeks of storage at 90° F.

| | | | | Difference |
|---|---|---|---|---|
| Storage | Storage | | Experimental | Between |
| Time | Temperature | Control | Sample | Samples |
| Week 6 | 70° F. | 4.1 | 2.8 | 1.3 |
| | 90° F. | 3.4 | 3 | 0.4 |
| Week 8 | 70° F. | 3.3 | 3.2 | 0.1 |
| | 90° F. | 4.2 | 3.4 | 0.8 |
| Week 10 | 70° F. | 4.5 | 3.8 | 0.7 |
| | 90° F. | 3.1 | 2.9 | 0.2 |
| Week 12 | 70° F. | 3.9 | 2.1 | 1.8 |
| | 90° F. | 4.5 | 3.8 | 0.7 |
| Month 5 | 70° F. | 3.9 | 2.9 | 1 |
| Month 7 | 70° F. | 4.5 | 2.1 | 2.4 |
| Month 9 | 70° F. | 5 | 2.9 | 2.1 |

As demonstrated in the table above, the inclusion of coconut water concentrate in the experimental sample appeared to slow the rate of flavor deterioration and oxidation as a result in the change of viscosity.

### Example 6

This example demonstrates how xanthan Gum and fructose impact viscosity when added to a beverage concentrate at different use levels. Viscosity was measured across multiple spindle speeds to differentiate non-Newtonian and Newtonian solutions from one another. Samples were prepared according to the formulations of Table 17 below. The viscosities and pH of the samples were measured using a Brookfield DV-II+Pro viscometer (Table 18). The pH and viscosity measurements were performed on the undiluted, concentrated samples at 20° C.

TABLE 17
Compositions of Control and Experimental Samples of 120X beverage concentrates.

| | | Experimental Samples | | | | | | | |
|---|---|---|---|---|---|---|---|---|---|
| | | 0.08% | 0.16% | 0.32% | 0.64% | 1.28% | 10% | 20% | 30% |
| | Control | Xanthan | Xanthan | Xanthan | Xanthan | Xanthan | Fructose | Fructose | Fructose |
| Water | 70.14% | 70.06% | 69.98% | 69.82% | 69.50% | 68.86% | 60.14% | 50.14% | 40.14% |
| Xanthan Gum | 0% | 0.08% | 0.16% | 0.32% | 0.64% | 1.28% | 0% | 0% | 0% |
| Fructose | 0% | 0% | 0% | 0% | 0% | 0% | 10.0% | 20.0% | 30.0% |
| Citric Acid | 16.50% | 16.50% | 16.50% | 16.50% | 16.50% | 16.50% | 16.50% | 16.50% | 16.50% |
| Malic Acid | 4.12% | 4.12% | 4.12% | 4.12% | 4.12% | 4.12% | 4.12% | 4.12% | 4.12% |
| Potassium | 1.50% | 1.50% | 1.50% | 1.50% | 1.50% | 1.50% | 1.50% | 1.50% | 1.50% |
| Citrate | | | | | | | | | |
| Acesulfame | 0.84% | 0.84% | 0.84% | 0.84% | 0.84% | 0.84% | 0.84% | 0.84% | 0.84% |
| Potassium | | | | | | | | | |
| Sucralose 25% | 6.85% | 6.85% | 6.85% | 6.85% | 6.85% | 6.85% | 6.85% | 6.85% | 6.85% |
| Solution | | | | | | | | | |
| Potassium | | | | | | | | | |
| Sorbate | 0.05% | 0.05% | 0.05% | 0.05% | 0.05% | 0.05% | 0.05% | 0.05% | 0.05% |
| Total Sum: | 100.0 | 100.0 | 100.0 | 100.0 | 100.0 | 100.0 | 100.0 | 100.0 | 100.0 |

TABLE 18
Viscosities of Control and Experimental Samples

| | Spindle | | | | | |
|---|---|---|---|---|---|---|
| Sample | Type | 10 RPM | 20 RPM | 50 RPM | 100 RPM | pH |
| Control | S00 | 4 | 4 | 4 | 4 | 2.12 |
| with 0.08% | S00 | 35 | 30 | 21 | 17 | 2.11 |
| Xanthan Gum | | | | | | |
| with 0.16% | S00 | 72 | 55 | 38 | 29 | 2.13 |
| Xanthan Gum | | | | | | |
| with 0.32% | S00 | 208 | 160 | 100 | Error | 2.12 |
| Xanthan Gum | | | | | | |
| with 0.64% | S06 | 3600 | 2200 | 1180 | 730 | 2.13 |
| Xanthan Gum | | | | | | |
| with 1.28% | S06 | 4300 | 2500 | 1300 | 800 | 2.12 |
| Xanthan Gum | | | | | | |
| with 10% | S00 | 7 | 7 | 7 | — | 2.13 |
| Fructose | | | | | | |
| with 20% | S00 | 14 | 14 | 14 | — | 2.11 |
| Fructose | | | | | | |
| with 30% | S00 | 39 | 39 | 39 | — | 2.12 |
| Fructose | | | | | | |

Thus, the inclusion of fructose or xanthan in the beverage concentrate increased the viscosity of the solution.

The foregoing descriptions are not intended to represent the only forms of the concentrate and methods in regard to the details of formulation. The percentages provided herein are by weight unless stated otherwise. Changes in form and in proportion of parts, as well as the substitution of equivalents, are contemplated as circumstances may suggest or render expedient. Similarly, while concentrates and methods have been described herein in conjunction with specific embodiments, many alternatives, modifications, and variations will be apparent to those skilled in the art in light of the foregoing description.

1. A flavored liquid beverage concentrate having a pH of about 1.8 to about 3.1, the concentrate comprising:
about 0.1 to about 15 percent acidulant;
about 0.1 to about 40 percent flavoring; and
a viscosity increasing agent in an amount effective to provide a viscosity of about 7.5 to about 100 cP as measured using a Brookfield Viscometer, Spindle S00 at 50 rpm at 20° C.,
wherein the concentrate has a concentration such that when diluted with a potable liquid at a ratio of about 1:5 to about 1:15 to provide a beverage, the concentrate delivers about 0.01 to 0.8 percent acid by weight of the beverage.

2. The flavored liquid beverage concentrate of claim 1, wherein the concentrate further comprises about 40 to about 98 percent water.

3. The flavored liquid beverage concentrate according to claim 1, wherein the concentrate has a viscosity of about 7.5 to about 50 cP as measured using a Brookfield Viscometer, Spindle S00 at 50 rpm at 20° C.

4. The flavored liquid beverage concentrate according to claim 1, wherein the concentrate has a viscosity of about 7.5 to about 20 cP as measured using a Brookfield Viscometer, Spindle S00 at 50 rpm at 20° C.

5. The flavored liquid beverage concentrate according to claim 1, wherein the concentrate has a pH of about 1.8 to about 2.7.

6. The flavored liquid beverage concentrate according to claim 1, wherein the concentrate has a pH of about 1.8 to about 2.5.

7. The flavored liquid beverage concentrate according to claim 1, wherein the flavoring includes at least one of a terpene, terpene alcohol, aldehyde, sesquiterpene, terpenoid, or combination thereof.

8. The flavored liquid beverage concentrate according to claim 1, the concentrate further comprising an ingredient selected from the group consisting of betalain, annatto, red beet juice powder, Vitamin A, Vitamin C, Vitamin E, and combinations thereof.

9. The flavored liquid beverage concentrate according to claim 1, wherein the acidulant is an selected from the group consisting of citric acid, malic acid, succinic acid, acetic acid, hydrochloric acid, adipic acid, tartaric acid, fumaric acid, phosphoric acid, lactic acid, sodium acid pyrophosphate, salts thereof, and combinations thereof.

10. The flavored liquid beverage concentrate according to claim 1, wherein the flavoring includes a flavor key, and the acidulant and flavor key are provided in a ratio of about 1:2 to about 10,000:1.

11. The flavored liquid beverage concentrate according to claim 1, wherein the acidulant and flavor key are provided in a ratio of about 1:1 to about 4000:1.

12. A flavored liquid beverage concentrate having a pH of about 1.8 to about 3.1, the concentrate comprising:
about 3 to about 60 percent acidulant;
about 0.5 to about 40 percent flavoring; and
a viscosity increasing agent in an amount effective to provide a Newtonian liquid viscosity of about 7.5 to about 100 cP as measured using Spindle S00 at 10 rpm at 20° C. or a non-Newtonian liquid viscosity of about 7.5 to about 10,000 cP as measured using Spindle S00 at 10 rpm at 20° C.,
wherein the concentrate has a concentration such that when diluted with a potable liquid at a ratio of about 1:50 to about 1:160 to provide a beverage, the concentrate delivers about 0.01 to 0.8 percent acid by weight of the beverage.

13. The flavored liquid beverage concentrate of claim 12, wherein the concentrate further comprises about 40 to about 90 percent water.

14. The flavored liquid beverage concentrate according to claim 12, wherein the concentrate has a Newtonian liquid viscosity of about 7.5 to about 50 cP as measured using Spindle S00 at 10 rpm at 20° C. or a non-Newtonian liquid viscosity of 7.5 to about 5,000 cP as measured using Spindle S00 at 10 rpm at 20° C.

15. The flavored liquid beverage concentrate according to claim 12, wherein the concentrate has a Newtonian liquid viscosity of about 7.5 to about 40 cP as measured using Spindle S00 at 10 rpm at 20° C. or a non-Newtonian liquid viscosity of 7.5 to about 1,000 cP as measured using Spindle S00 at 10 rpm at 20° C.

16. The flavored liquid beverage concentrate according to claim 12, wherein the concentrate has a pH of about 1.8 to about 2.7.

17. The flavored liquid beverage concentrate according to claim 12, wherein the concentrate has a pH of about 1.8 to about 2.5.

18. The flavored liquid beverage concentrate according to claim 12, wherein the flavoring includes at least one of a terpene, sesquiterpene, terpene alcohol, aldehyde, terpenoid, or combination thereof.

19. The flavored liquid beverage concentrate according to claim 12, the concentrate further comprising an ingredient selected from the group consisting of betalain, armatto, red beet juice powder, Vitamin A, Vitamin C, Vitamin E, and combinations thereof.

20. The flavored liquid beverage concentrate according to claim 12, wherein the acidulant is an selected from the group consisting of citric acid, malic acid, succinic acid, acetic acid, hydrochloric acid, adipic acid, tartaric acid, fumaric acid, phosphoric acid, lactic acid, sodium acid pyrophosphate, salts thereof, and combinations thereof.

21. The flavored liquid beverage concentrate according to claim 11, wherein the flavoring includes a flavor key, and the acidulant and flavor key are provided in a ratio of about 1:2 to about 10,000:1.

22. The flavored liquid beverage concentrate according to claim 12, wherein the acidulant and flavor key are provided in a ratio of about 1:1 to about 4000:1.

23. The flavored liquid beverage concentrate according to claim 12, further comprising about 0.5 to about 10.0 percent buffer.
